(19) United States
(12) Patent Application Publication
(10) Pub. No.: US 2024/0256884 A1
(43) Pub. Date: Aug. 1, 2024

(54) GENERATING ENVIRONMENT MODELS USING IN-CONTEXT ADAPTATION AND EXPLORATION

(71) Applicant: DeepMind Technologies Limited, London (GB)

(72) Inventors: Hado Philip van Hasselt, London (GB); Nan Ke, London (GB); Chentian Jiang, Edinburgh (GB)

(21) Appl. No.: 18/424,687

(22) Filed: Jan. 26, 2024

Related U.S. Application Data
(60) Provisional application No. 63/441,425, filed on Jan. 26, 2023.

(51) Int. Cl. G06N 3/092; G06N 3/042

(52) U.S. Cl. CPC G06N 3/092; G06N 3/042

(57) ABSTRACT

Methods, systems, and apparatus, including computer programs encoded on computer storage media, for controlling an agent interacting with an environment to perform a task. In one aspect, one of the methods include: maintaining context data; receiving a current observation characterizing a current state of the environment; generating a current graph model that represents the environment; selecting, from a possible set of actions and using the current graph model, a current action to be performed by the agent in response to the current observation; controlling the agent to perform the selected current action to cause the environment to transition from the current state into a new state; and updating the context data to include (i) data identifying the selected current action and (ii) a new observation characterizing the new state of the environment.

### CROSS-REFERENCE TO RELATED APPLICATION

This application claims priority to U.S. Provisional Application No. 63/441,425, filed on Jan. 26, 2023. The disclosure of the prior application is considered part of and is incorporated by reference in the disclosure of this application.

### BACKGROUND

This specification relates to reinforcement learning.

In a reinforcement learning system, an agent interacts with an environment by performing actions that are selected by the reinforcement learning system in response to receiving observations that characterize the current state of the environment.

Some reinforcement learning systems select the action to be performed by the agent in response to receiving a given observation in accordance with an output of a neural network.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes an agent control system implemented as computer programs on one or more computers in one or more locations that selects actions to be performed by an agent interacting with an environment. In particular, the agent control system uses a graph model in selecting actions to be performed in response to observations of the environment. The graph model is a latent representation of an environment that is generated by the system based on past interaction of the agent with the environment.

The subject matter described in this specification can be implemented in particular embodiments so as to realize one or more of the following advantages. A graph model of an environment with unknown relationship between possible states of the environment can be quickly and accurately generated as agent interacts with the environment by performing actions. Guided by the more accurate outputs generated using a neural network by virtue of processing more context data that characterizes a longer sequence of past interaction between the agent and the environment, the in-context adaptation and exploration techniques described in this specification can facilitate fast generation of a graph model that accurately represents the underlying state transitions of any environment, and can generalize well to a wide range of reinforcement learning tasks without the need to re-train the neural network. By employing a graph model generated as described in this specification, an agent can be controlled to achieve better performance on various kinds of tasks because actions that would lead to higher task rewards or quicker achievement of task goals can be more accurately determined from the graph model representation of the environment.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example agent control system.

FIG. 2 is an example illustration of a current graph model that represents an environment at a time step.

FIG. 3 is a flow diagram of an example process for controlling an agent interacting with an environment to perform an episode of a task.

FIG. 4 is a flow diagram of sub-steps of one of the steps of the process of FIG. 3.

FIG. 5 is a flow diagram of sub-steps of another one of the steps of the process of FIG. 3.

FIG. 6 shows an example illustration of generating a graph model by using a neural network.

FIG. 7 is a flow diagram of an example process for training a neural network that is used to generate the graph model.

Like reference numbers and designations in the various drawings indicate like elements.

### DETAILED DESCRIPTION

This specification describes an agent control system implemented as computer programs on one or more computers in one or more locations that controls an agent to interact with an environment by, at any given time step, causing the agent to perform an action selected using a graph model and an observation that characterizes the state of the environment at the given time step.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

In some implementations, the reinforcement learning situation includes a reward calculation unit for generating a reward (e.g. in the form of a number), typically from the observation. The rewards may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the metric may comprise any metric of usage of the resource. In the case of a task which is to control an electromechanical agent such as a robot to perform a manipulation of an object, the reward may indicate whether the object has been correctly manipulated according to a predefined criterion.

In general, observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case that the agent is a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor (e.g. mounted on the machine). Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general, the observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards may relate to a metric of performance of a task relating to the efficient operation of the facility. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards may relate to a metric of performance of a task relating to power distribution. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g. by controlling synthesis steps selected by the system automatically without human interaction. The observations may comprise direct or indirect observations of a state of the protein or chemical/intermediates/precursors and/or may be derived from simulation. Thus the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound pharmaceutically active compound and the agent is a computer system for determining elements of the pharmaceutically active compound and/or a synthetic pathway for the pharmaceutically active compound. The drug/synthesis may be designed based on a reward derived from a target for the pharmaceutically active compound, for example in simulation. As another example, the agent may be a mechanical agent that performs or controls synthesis of the pharmaceutically active compound.

In some further applications, the environment is a real-world environment and the agent manages distribution of tasks across computing resources e.g. on a mobile device and/or in a data center. In these implementations, the actions may include assigning tasks to particular computing resources. In these applications, the observations may include observations of computing resources such as compute and/or memory capacity, or Internet-accessible resources; and the actions may include assigning tasks to particular computing resources. The reward(s) may be configured to maximize or minimize one or more of: utilization of computing resources, electrical power, bandwidth, and computation speed.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e. observations of a mechanical shape or of an electrical, mechanical, or electro-mechanical configuration of the entity, or observations of parameters or properties of the entity. The actions may comprise actions that modify the entity e.g. that modify one or more of the observations. The rewards may comprise one or more metrics of performance of the design of the entity. For example rewards may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, the reinforcement learning system may output to the human user, via the digital assistant, instructions for actions for the user to perform at each of a plurality of time steps. The instructions may for example be generated in the form of natural language (transmitted as sound and/or text on a screen) based on actions chosen by the reinforcement learning system. The reinforcement learning system chooses the actions such that they contribute to performing a task. A monitoring system (e.g. a video camera system) may be provided for monitoring the action (if any) which the user actually performs at each time step, in case (e.g. due to human error) it is different from the action which the reinforcement learning system instructed the user to perform. Using the monitoring system the reinforcement learning system can determine whether the task has been completed. During an on-policy training phase and/or another phase in which the history database is being generated, the experience tuples may record the action which the user actually performed based on the instruction, rather than the one which the reinforcement learning system instructed the user to perform. The reward value of each experience tuple may be generated, for example, by comparing the action the user took with a corpus of data showing a human expert performing the task, e.g. using techniques known from imitation learning. Note that if the user performs actions incorrectly (i.e. performs a different action from the one the reinforcement learning system instructs the user to perform) this adds one more source of noise to sources of noise which may already exist in the environment. During the training process the reinforcement learning system may identify actions which the user performs incorrectly with more than a certain probability. If so, when the reinforcement learning system instructs the user to perform such an identified action, the reinforcement learning system may warn the user to be careful. Alternatively or additionally, the reinforcement learning system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow or Chinchilla. The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

In some implementations, the environment may not include a human being or animal. In other implementations, however, it may comprise a human being or animal. For example, the agent may be an autonomous vehicle in an environment which is a location (e.g. a geographical location) where there are human beings (e.g. pedestrians or drivers/passengers of other vehicles) and/or animals, and the autonomous vehicle itself may optionally contain human beings. The environment may also be at least one room (e.g. in a habitation) containing one or more people. The human being or animal may be an element of the environment which is involved in the task, e.g. modified by the task (indeed, the environment may substantially consist of the human being or animal). For example the environment may be a medical or veterinary environment containing at least one human or animal subject, and the task may relate to performing a medical (e.g. surgical) procedure on the subject. In a further implementation, the environment may comprise a human user who interacts with an agent which is in the form of an item of user equipment, e.g. a digital assistant. The item of user equipment provides a user interface between the user and a computer system (the same computer system(s) which implement the reinforcement learning system, or a different computer system). The user interface may allow the user to enter data into and/or receive data from the computer system, and the agent is controlled by the action selection policy to perform an information transfer task in relation to the user, such as providing information about a topic to the user and/or allowing the user to specify a component of a task which the computer system is to perform. For example, the information transfer task may be to teach the user a skill, such as how to speak a language or how to navigate around a geographical location; or the task may be to allow the user to define a three-dimensional shape to the computer system, e.g. so that the computer system can control an additive manufacturing (3D printing) system to produce an object having the shape. Actions may comprise outputting information to the user (e.g. in a certain format, at a certain rate, etc.) and/or configuring the interface to receive input from the user. For example, an action may comprise setting a problem for a user to perform relating to the skill (e.g. asking the user to choose between multiple options for correct usage of the language, or asking the user to speak a passage of the language out loud), and/or receiving input from the user (e.g. registering selection of one of the options, or using a microphone to record the spoken passage of the language). Rewards may be generated based upon a measure of how well the task is performed. For example, this may be done by measuring how well the user learns the topic, e.g. performs instances of the skill (e.g. as measured by an automatic skill evaluation unit of the computer system). In this way, a personalized teaching system may be provided, tailored to the aptitudes and current knowledge of the user. In another example, when the information transfer task is to specify a component of a task which the computer system is to perform, the action may comprise presenting a (visual, haptic or audio) user interface to the user which permits the user to specify an element of the component of the task, and receiving user input using the user interface. The rewards may be generated based on a measure of how well and/or easily the user can specify the component of the task for the computer system to perform, e.g. how fully or well the three-dimensional object is specified. This may be determined automatically, or a reward may be specified by the user, e.g. a subjective measure of the user experience. In this way, a personalized system may be provided for the user to control the computer system, again tailored to the aptitudes and current knowledge of the user.

Optionally, in any of the above implementations, the observation at any given time step may include data from a previous time step that may be beneficial in characterizing the environment, e.g., the action performed at the previous time step, the reward received at the previous time step, or both.

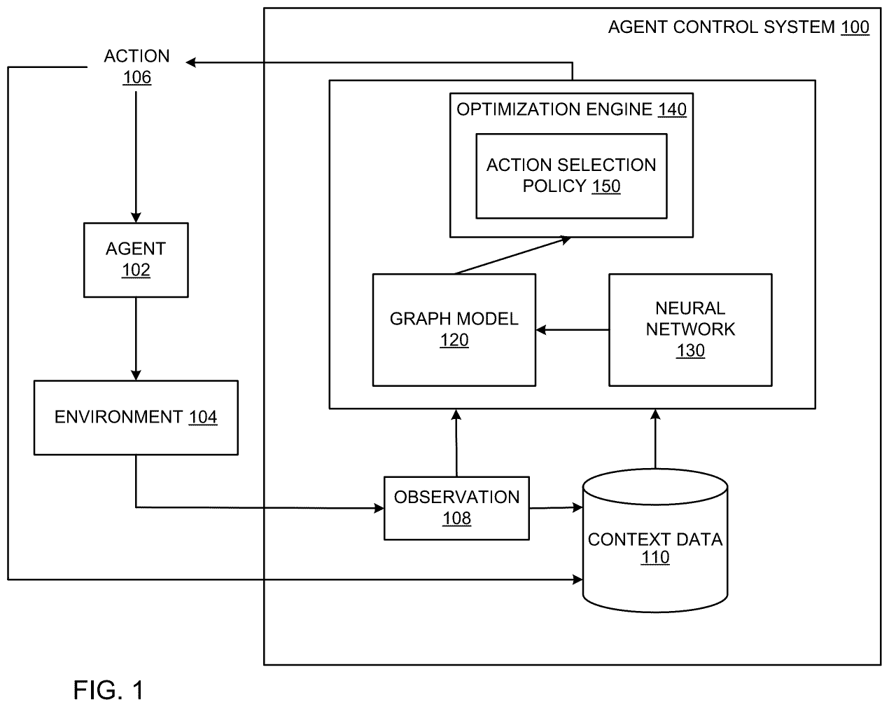

FIG. 1 shows an example agent control system 100. The agent control system 100 is an example of a system implemented as computer programs on one or more computers in one or more locations in which the systems, components, and techniques described below are implemented.

The agent control system 100 controls an agent 102 interacting with an environment 104 by, at each of multiple time steps during the performance of an episode of a specified task, processing data characterizing the current state of the environment 104 at the time step (i.e., a current “observation” 108) to generate a model representing the environment 104 at the time step (i.e., a current “graph model” 120) and uses the current graph model 120 to select an action 106 to be performed by the agent 102 in response to the current observation 108.

The agent control system 100 then causes the agent 102 to perform the selected action 106, such as by transmitting control data to the agent which instructs the agent to perform the selected action. Performance of the selected actions 106 by the agent 102 generally causes the environment 104 to transition into new states. By repeatedly causing the agent 102 to act in the environment, the agent control system 100 can control the agent 102 to complete the specified task.

An “episode” of a task is a sequence of interactions during which the agent 102 attempts to perform a single instance of the task starting from some starting state of the environment 104. In other words, each task episode begins with the environment 104 being in an initial state, e.g., a fixed initial state or a randomly selected initial state, and ends when the agent 102 has successfully completed the task or when some termination criterion is satisfied, e.g., the environment 104 enters a state that has been designated as a terminal state or the agent 102 performs a threshold number of actions 106 without successfully completing the task.

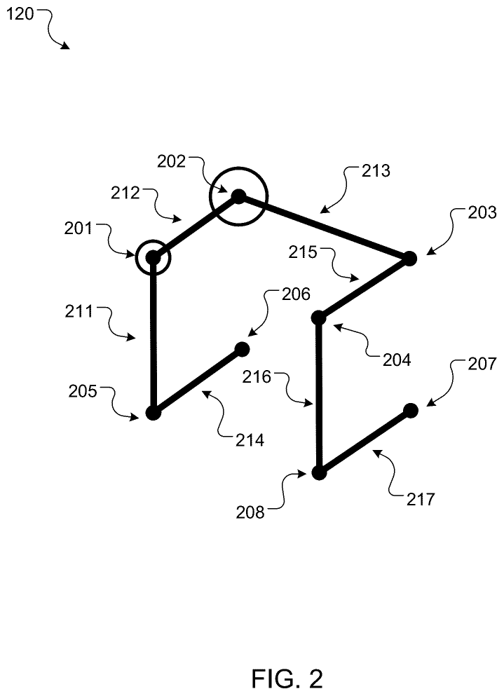

FIG. 2 is an example illustration of the current graph model 120 that represents the environment 104 at a given time step. In this specification, a graph model is a data structure that can be represented by a set of vertices 201-208 and a set of edges 211-217. Each vertex represents a corresponding state of the environment 104. In FIG. 2, for example, vertex 201 represents a first state of the environment 104, vertex 202 represents a second state of the environment 104, vertex 203 represents a third state of the environment 104, vertex 204 represents a fourth state of the environment 104, and so on. Collectively, the set of vertices 201-208 represent at least a portion of a possible state space of the environment 104.

Each vertex is associated with a reward value. That is, the graph model includes data that defines, for each of the set of vertices 201-208, a reward value, e.g., a scalar reward value, for the vertex. The reward value for a given vertex defines a reward that can be received by the agent 102 when the environment 104 is in a corresponding state represented by the given vertex.

FIG. 2 thus illustrates that a first reward is placed on the vertex 201 representing the first state of the environment 104 and a second reward is placed on vertex 202 representing the second state of the environment 104. In FIG. 2, for example, the first state is associated with a smaller reward (as indicated by the smaller circle), e.g., a zero reward, while the second state is associated with a larger reward (as indicated by the larger circle), e.g., a positive reward.

Each edge connects a pair of vertices. For example, an edge 212 connects vertex 201 and vertex 202, an edge 213 connects vertex 202 and vertex 204, and so on. Each edge is associated with a possible set of actions that can be performed by the agent 102 when the environment 104 is in a state represented by one of the vertices in the pair.

Each edge connecting a pair of vertices represents a feasibility indicating it is possible that the environment 104 could transition between the two states represented by the vertices included in the pair, respectively, by virtue of the agent 102 performing one of the set of possible actions associated with the edge when the environment 104 is in a state represented by one of the vertices in the pair. For example, the edge 212 connecting vertex 201 and vertex 202 represents a feasibility indicating it is possible that the environment 104 could transition from the first state represented by vertex 201 into the second state represented by vertex 202, by virtue of the agent 102 performing one of the set of possible actions associated with the edge 212 when the environment 104 is in the first state or the second state.

Thus, in some cases, the graph model 120 can represent a Markov decision process (MDP), where the existence of an edge between a pair of vertices represents a state transition function between the two states of the environment 104 represented by the vertices in the pair. Stated differently, if an edge exists between a pair of vertices, then the two states represented by the pair of vertices are consecutive states of the environment; alternatively, if no edge exists between a pair of vertices, then the two states represented by the pair of vertices are nonconsecutive states of the environment, e.g., they may be separated by one or more intermediate states.

Assuming that the current graph model 120 illustrated in FIG. 2 is an accurate representation of the environment 104, then the environment cannot transition directly from the first state represented by vertex 201 into the fourth state represented by vertex 204, because there is not an edge between vertex 201 and vertex 204. Instead, to transition from the first state represented by vertex 201 into the fourth state represented by vertex 204, the agent 102 could perform an action 106 when the environment 104 is in the first state represented by vertex 201 that will cause the environment 104 to transition into the second state represented by vertex 202, perform another action 106 when the environment 104 is in the second state represented by vertex 202 that will cause the environment 104 to transition into the third state represented by vertex 203, and perform yet another action 106 when the environment 104 is in the third state represented by vertex 203 that will cause the environment 104 to transition into the fourth state represented by vertex 204.

Controlling the agent 102 to interact with different environments 104 or to perform different tasks, e.g., within the same or different environments 104, will require different graph models. Typically, different environments 104 are represented by different graph models 120. Moreover, performing different tasks within the same environment 104 may also require different graph models, because the way the states of the environment 104 transition from one to another, the way the rewards at different states of the environment 104 are determined, the possible set of actions 106 that can be performed by the agent 102 to interact with the environment 104, or some combination of aspects and possibly other aspects of the task will usually differ from one task to another.

In particular, the agent control system 100 is capable of in-context adaptation of the graph model 120 to different environments or different tasks, without needing to additionally train the trainable components of the system. While performing any given task episode, the agent control system 100 updates the graph model 120 over the course of the task episode based on the interactions between the agent 102 and the environment 104.

In implementations described throughout this specification, the agent control system 100 updates the graph model 120 at each of multiple time steps during a given task episode, and then uses the graph model 120 that has been updated as of the time step to select an action 106 to be performed by the agent 102.

In other implementations, however, the graph model 120 can be updated at a lower frequency, e.g., at every fixed number of time steps, e.g., at every two, five, ten, or more time steps, during the given task episode, or according to a custom update schedule, and thus the most recently updated graph model 120 may be used to select an action 106 to be performed by the agent 102 at two or more different time steps.

To assist in the adaptation of the graph model 120, the agent control system 100 uses context data 110 generated as a result of previous interaction between the agent 102 and the environment 104 since the beginning of the task episode, and a neural network 130 that processes the context data 110 to generate network outputs that can be used to update the graph model 120 so that it more accurately represents the environment 104.

The context data 110 includes data identifying previous actions performed by the agent and previous observations characterizing previous states of the environment (up to the current state) during the task episode. That is, at any given time step during the task episode, the context data 110 includes data identifying, for each of one or more previous time steps that precede the given time step, a previous action 106 performed by the agent 102 and a previous observation characterizing a previous state that the environment 104 transitioned into as a result of the agent performing the previous action 106.

The neural network 130 is configured to, at any given time step during the task episode, receive a first network input for the given time step that includes the context data 110 and process the input to generate a first network output for the given time step that includes a probability distribution over all edges in a possible set of edges that can be included in the graph model 120. The probability distribution includes a respective probability score for each edge in the possible set of edges.

In addition, the first network output for the given time step includes a probability distribution over a possible set of vertex-edge pairs (where each pair includes one of a possible set of vertices and an edge connected to the vertex) included in the current graph model 120. The probability distribution includes a respective probability score for each vertex-edge pair in the possible set of vertex-edge pairs.

The agent control system 100 then uses the first network for the given time step to update the graph model 120, i.e., to modify the most recently updated graph model 120. In particular, the agent control system 100 selects, from the possible set of edges, one or more edges to be included in the current graph model 120 using the probability distribution over the possible set of edges. In addition, the agent control system 100 determines, for each vertex in the possible set of vertices that is included in the current graph model 120, a reward value using the probability distribution over the possible set of vertex-edge pairs. The updated graph model 120 after being updated using the first network output for the given time step will be referred to in this specification as the current graph model 120 that represents the environment 104.

After generating the current graph model 120, the agent control system 100 uses an optimization engine 140 in tandem with the current graph model 120 to generate an action selection policy 150, as will be described further below.

The neural network 130 is also configured to, at any given time step during the task episode, process a second network input to generate a second network output for the given time step that includes a probability distribution over the possible set of vertices that is included in the current graph model 120. This probability distribution includes a respective probability score for each vertex in the possible set of vertices.

In some implementations, the second network input is the same as the first network input, and the neural network 130 is configured to generate the second network output together with the first network output by processing the same network input, e.g., generate the second network output after the first network output in an auto-regressive manner. In other implementations, the second network input for the given time step is different from the first network input, e.g., the second network input can be a portion of the first network input that includes only the current observation 108.

The agent control system 100 selects, as a vertex in the current graph model 120 that corresponds to the current observation 108, a vertex from the possible set of vertices using the probability distribution included in the second network output. The agent control system 100 then uses the selected vertex to query the action selection policy 150 to select the action 106 to be performed by the agent 102 in response to the current observation 108.

In implementations the neural network 130 can have any appropriate architecture, e.g., a Transformer neural network architecture or a recurrent neural network architecture. For example, the neural network 130 can be configured as a Transformer neural network that includes (i) a plurality of attention blocks that each apply a self-attention operation and (ii) an output subnetwork that processes an output of the last attention block to generate the probability distribution. As another example, the neural network 130 can be configured as a recurrent neural network includes (i) a plurality of recurrent layers, e.g., long short-term memory network (LSTM) layers or gated recurrent unit (GRU) layers and (ii) an output layer that processes an output of the last recurrent layer to generate the probability distribution.

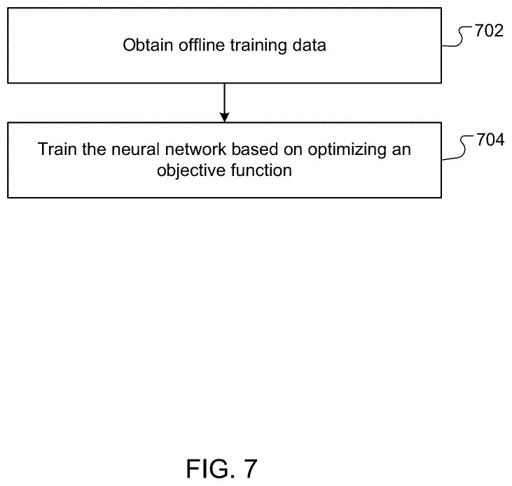

A specific example of the neural network 130 that has a Transformer architecture is described for illustrative purposes. Moreover, training the neural network 130 that has the Transformer architecture will be described further below with reference to FIG. 7. It will be appreciated that, in other examples, the neural network 130 may have different architectures and may be trained using similar or different ways.

Input layer. The input layer receives as input a context matrix C of size T×X, where T is the number of time steps in an episode and X is the dimension of an input sequence representing a previous action aₜ performed by the agent at the previous time step t in the episode and a previous observation sₜ₊₁ characterizing a previous state that the environment transitioned into as a result of the agent performing the previous action.

Embedding and positional encoding subnetwork. The embedding and positional encoding subnetwork includes a multi-layer perceptron (MLP), a convolutional neural network, or both. The embedding and positional encoding subnetwork embeds each input sequence of (aₜ, sₜ₊₁) into an embedded vector. The embedding and positional encoding subnetwork also adds positional encodings to the embedded vector over the time step dimension.

Attention blocks. Each attention block includes an attention layer that applies a multi-headed self-attention operation (which operates over the time step dimension) and a fully connected feed-forward neural network. In cases where the Transformer neural network includes multiple attention blocks, they can be stacked, where the input for the first attention block is the embedded vector generated by the embedding and positional encoding subnetwork, and the input for each subsequent attention block is the output generated by the preceding attention block.

Output subnetwork. The output subnetwork includes an MLP followed by one or more non-linear activation layers. For example, the sequence of non-linear activation layers includes one or more sigmoid layers (that generate can a Bernoulli distribution), one or more softmax layers (that can generate a categorical distribution), or both. The output subnetwork processes the output of the last attention block to generate an output in the size of T×Y, where Y is the length of a vector e plus the length of a vector r plus the number of vertices in the possible set of vertices that is included in the current graph model 120. The length of the vector e depends on, e.g., is equal to, the number of the possible set of edges that can be included in the graph model, and the length of the vector r depends on, e.g., is equal to, the number of the possible vertex-edge pairs that can be included in the graph model.

At any given time step during the task episode, to select an action 106 to be performed by the agent 102 at the given time step, the optimization engine 140 uses the current graph model 120 to generate an action selection policy 150, and then selects the action 106 to be performed by the agent 102 in response to the current observation 108 received in the given time step in accordance with the action selection policy 150.

The action selection policy 150 attempts to maximize a return that is received over the course of the task episode by the agent 102. That is, at any given time step during the task episode, the action selection policy 150 attempts to maximize an estimated total reward, which is determined from the data made available by the current graph model 120, that will be received by the agent 102 in response to performing actions selected in accordance with the action selection policy 150 for the remainder of the task episode starting from the time step, i.e., starting from the current state of the environment 104 characterized by the current observation 108 at the given time step.

To that end, the action selection policy 150 can define the action 106 to be performed by the agent 102 at each given time step in any of a variety of ways. In some implementations, the action selection policy 150 specifies a mapping, e.g., a one-to-one mapping or a many-to-one mapping, from each of the vertices included in the current graph model 120 to an action in the possible set of actions.

In implementations, the optimization engine 140 can execute any of a variety of optimization algorithms using data made available by the current graph model 120 to generate an action selection policy 150 for the given time step. In some implementations, the optimization engine 140 can use a conventional dynamic programming technique, e.g., one of the techniques described in Richard E. Bellman, Dynamic Programming. Princeton University Press, 1957, to generate the action selection policy 150.

One common example of dynamic programming technique for agent control is the value iteration technique. In value iteration, the optimization engine 140 maintain an approximate value function that depends on the estimated total reward, and iteratively updates the approximate value function by solving the Bellman equations until it converges, or after a predetermined number of update iterations have been performed.

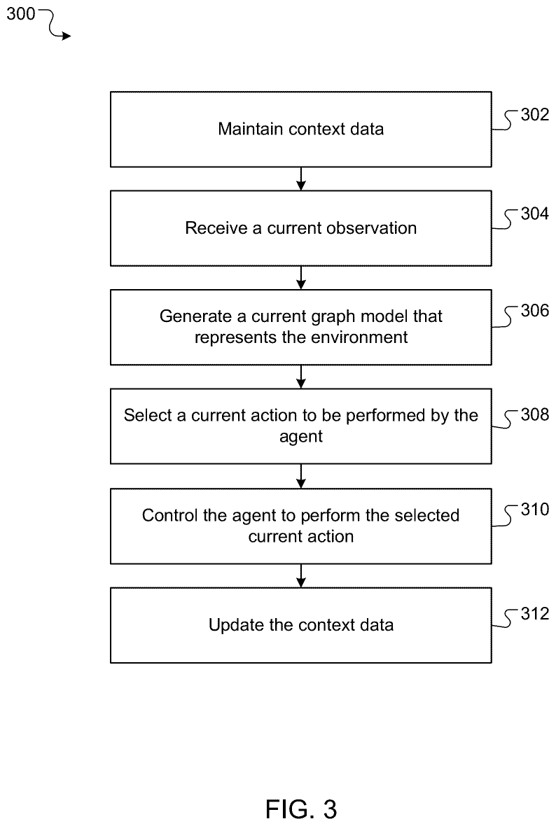

FIG. 3 is a flow diagram of an example process 300 for controlling an agent interacting with an environment to perform an episode of a task. For convenience, the process 300 will be described as being performed by a system of one or more computers located in one or more locations. For example, an agent control system, e.g., the agent control system 100 of FIG. 1, appropriately programmed, can perform the process 300.

The system can repeatedly perform an iteration of the process 300 at each of multiple time steps (referred to below as the “current time step”) during the episode of the task. The system can end performing iterations of the process 300 when the agent has successfully completed the task or when some termination criterion is satisfied, e.g., the environment enters a state that has been designated as a terminal state or the agent performs a threshold number of actions without successfully completing the task.

The system maintains context data (step 302). The context data includes, for each of one or more previous time steps that precede the current time step, (i) data identifying a previous action performed by the agent at the previous time step and (ii) a previous observation characterizing a previous state that the environment transitioned into as a result of the agent performing the previous action.

The system receives a current observation characterizing a current state of the environment (step 304). For example, the current observation can be or include an image or a video frame.

The system generates a current graph model that represents the environment by using a neural network conditioned on the context data (step 306). The current graph model includes vertices that represent states of the environment and edges connecting the vertices. An edge between a first vertex and a second vertex in the graph model indicates it is possible that the environment will transition from a state represented by the first vertex into a state represented by the second vertex as a result of one of a possible set of actions performed by the agent. The current graph model also includes data that defines, for each vertex in the possible set of vertices, a reward value for the vertex. The reward value for a given vertex defines a reward that can be received by the agent when the environment is in a corresponding state represented by the given vertex.

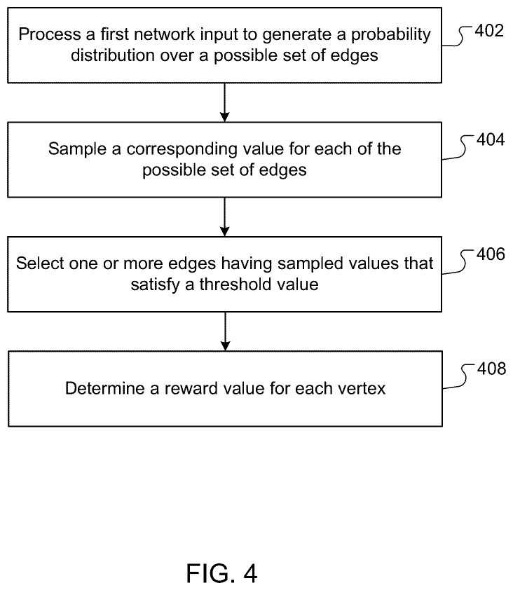

The neural network can be, for example, a Transformer neural network or a recurrent neural network. Generating the current graph model using the neural network is explained in more detail with reference to FIG. 4, which shows sub-steps 402-408 corresponding to step 306.

The system processes a first network input that includes the context data using the neural network and in accordance with parameters of the neural network to generate a first network output for the current time step (step 402). In particular, the values of the parameter of the neural network are fixed, i.e., will not be adjusted, across the multiple time steps during the episode of the task.

The first network output includes a probability distribution over a possible set of edges that can be included in the current graph model. The probability distribution includes a respective probability score for each edge in the possible set of edges.

The first network output also includes a probability distribution over a possible set of vertex-edge pairs (where each pair includes one of a possible set of vertices and an edge connected to the vertex) included in the current graph model. The probability distribution includes a respective probability score for each vertex-edge pair in the possible set of vertex-edge pairs.

The system then performs steps 404-406 to select, from the possible set of edges that can be included in the current graph model, a subset of the edges for inclusion in the current graph model.

The system determines a respective transition value for each of the possible set of edges using the probability distribution over the possible set of edges (step 404). For example, the respective transition value for each of the possible set of edges can be the same as the probability score for the edge. As another example, the respective transition value for each of the possible set of edges can be another value that is dependent on the probability score for the edge. For example, each edge can have a binary transition value that is set to a first value (e.g., one, or another positive value) when the probability score for the edge is above an edge probability score threshold, and is set to a second value (e.g., zero, or another negative value) when the probability score for the edge is below the edge probability score threshold.

The system selects, from the possible set of edges, one or more edges based on the transition values (step 406). For example, the system can select one or more edges that have the highest determined transition values amongst the possible set of edges for inclusion in the current graph model. As another example, the system can select one or more edges that have determined transition values that are greater than a given threshold value for inclusion in the current graph model. In particular, the current graph model will only include the selected edges and will exclude, i.e., will not include, any other edges in the possible set of edges that have not been selected.

The system determines, for each vertex in the possible set of vertices included in the current graph model, a reward value using the probability distribution over the possible set of vertex-edge pairs (step 408). For example, the reward value for each of the possible set of vertices can be determined based on the respective probability scores for one or more vertex-edge pairs that each include the vertex. For example, each vertex can have a binary reward value that is set to a first value (e.g., one, or another positive value) when the probability score for at least one of vertex-edge pairs that include the vertex is above a vertex probability score threshold, and is set to a second value (e.g., zero, or another negative value) when the probability scores for all of vertex-edge pairs that include the vertex are below the vertex probability score threshold.

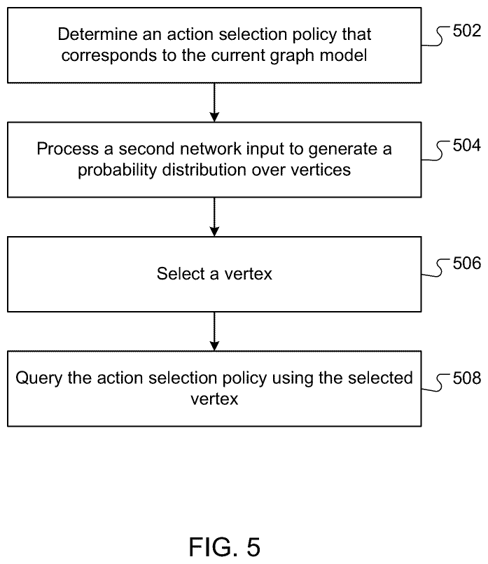

The system selects, using the current graph model, a current action to be performed by the agent in response to the current observation (step 308). Selecting the current action is explained in more detail with reference to FIG. 5, which shows sub-steps 502-508 corresponding to step 308.

The system determines an action selection policy that corresponds to the current graph model (step 502). In some implementations, the action selection policy specifies a mapping from each of the vertices included in the current graph model to an action in the possible set of actions.

In some implementations, the system uses a dynamic programming technique based on data made available by the current graph model to generate the action selection policy. For example, the dynamic programming technique can be a value iteration technique that iteratively determines an action selection policy using the edges that have been selected for inclusion in the current graph model, and the reward value that has been determined for each vertex in the possible set of vertices included in the current graph model.

The system processes a second network input using the Transformer neural network and in accordance with parameters of the neural network to generate a second network output for the given time step that includes a probability distribution over the possible set of vertices that is included in the current graph model (step 504). The probability distribution includes a respective probability score for each vertex in the possible set of vertices.

In some implementations, the second network input is the same as the first network input, and the neural network is configured to generate the second network output together with the first network output by processing the same network input, e.g., to generate the second network output after the first network output in an auto-regressive manner. In other implementations, the second network input for the given time step is different from the first network input, e.g., the second network input can be a portion of the first network input that includes only the current observation.

The system selects, in accordance with the probability distribution over the possible set of vertices that is included in the graph model, a selected vertex as a vertex in the current graph model that corresponds to the current observation (step 506). In other words, the selected vertex is a vertex in the current graph model that represents the current state of the environment. For example, the system can select a vertex that has the highest probability amongst the possible set of vertices or can sample a vertex from the probability distribution.

The system selects, from a possible set of actions, a current action to be performed by the agent by querying the action selection policy using the selected vertex (step 508). The possible set of actions can include any of the previously described actions and, in some implementations, a no-operation action. A no-operation action, or a “no-op” action is an action that, when performed, does not result in any change to the environment. That is, the environment remains in the same state after a “no-op” action is performed by the agent in response to receiving an observation characterizing that state.

The system controls the agent to perform the selected current action, e.g., by instructing the agent to perform the selected action or passing a control signal to a control system for the agent, to cause the environment to transition from the current state into a new state (step 310).

The system updates the context data to include (i) data identifying the selected current action and (ii) a new observation characterizing the new state of the environment (step 312).

By repeatedly performing iterations of process 300 to sample from the network outputs generated by the neural network across the multiple time steps during the episode of the task, the system can generate different graph models at different time steps. In particular, the graph models at different time steps may include different numbers of edges, or may include the same number of edges that connect the vertices in different ways. Over time, graph models that more accurately represent the environment will be generated as more context data becomes available to the neural network despite that its parameter values remain fixed. Selecting actions to be performed by the agent in response to each observation in accordance with an action selection policy generated from such a graph model typically improves the task performance of the agent over the course of the episode by virtue of the improved accuracy in the representation of the environment by the graph model.

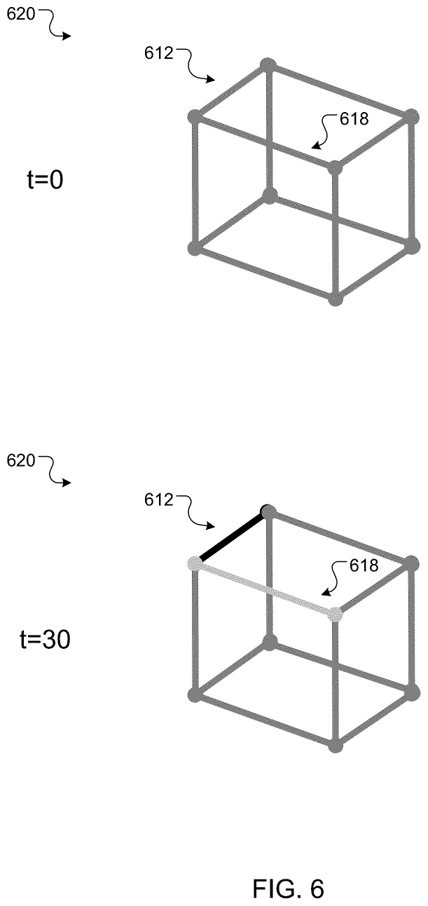

FIG. 6 shows an example illustration of generating a graph model 620 by using a neural network. The graph model 620 can correspond to the graph model 120 shown in FIG. 2.

At time step t=0, the first network output of the neural network includes an initial probability score for edge 612, and an initial probability score for edge 618. At time step t=30, the first network output of the neural network includes an updated probability score for edge 612, and an updated probability score for edge 618.

Assuming that the graph model shown in FIG. 2 is an accurate representation of the environment, a more accurate graph model that is closer to the graph model shown in FIG. 2 can generally be generated based on the probability distribution generated by the neural network at time step t=30 compared with the probability distribution generated by the neural network at time step t=0 (by virtue of processing the additional context data generated between time steps t=0 and t=30).

FIG. 6 thus illustrates that, for edge 612, the updated probability score is higher than (as indicated by the darker color) the initial probability score. This increases the likelihood that edge 612 might be selected for inclusion in the graph model. On the other hand, for edge 618, the updated probability score is lower than (as indicated by the lighter color) the initial probability score. This reduces the likelihood that edge 618 might be selected for inclusion in the graph model.

An example algorithm for controlling an agent interacting with an environment to perform an episode of a task is shown below. At each time step during the episode, the example algorithm uses value iteration to generate an action selection policy π based on the current graph model, and then queries the action selection policy π using a selected vertex vₜ to determine which action aₜ from a possible set of actions to be performed by the agent.

Algorithm 1 Posterior Sampling

```
Require: Trained transformer parameters θ
  Initialize empty context matrix C
  for time step t in testing episode do
    if full method then
      Sample e, r ~ \hat{p}_{θ}(e, r|C)
    else if ablation then
      e ← [symbol]   _{\hat{p}θ}(e|C) [e]; r ← [symbol]   _{\hat{p}θ}(r|C) [r]
    end if
    Value iteration with e and r (transition and reward functions
    in partial model space) produces π : [symbol]    → [symbol]
    vₜ ← arg maxᵥ_{ₜ} \hat{p}_{θ}(vₜ|sₜ)
    xₜ ← π(vₜ)
    Map xₜ to aₜ (action in real env); observe sₜ₊₁
    Append (aₜ, sₜ₊₁) as a row to C
end for
```

FIG. 7 is a flow diagram of an example process 700 for training a neural network that is used to generate the graph model. For convenience, the process 700 will be described as being performed by a system of one or more computers located in one or more locations. For example, a system, e.g., the agent control system 100 of FIG. 1, or another training system, appropriately programmed in accordance with this specification, can perform the process 700.

The system obtains offline training data (step 702). The offline training data can be generated based on the interactions of the agent (or another agent) with an environment (or another instance of the environment).

In one example, the offline training data can be represented as p(C_{1:T}, k): for each training task k, the offline training includes multiple sequences of context data C_{1:T} (data identifying previous actions aₜ and previous observations sₜ₊₁) generated while the agent is controlled using a predetermined action selection policy, e.g., a random policy. Each sequence of context data includes T time steps. For each training task k, each sequence of context data C_{1:T} is associated with a ground truth graph model that includes a set of ground truth edges et and ground truth reward values rₖ* for a set of vertices; each sequence of context data C_{1:T} is also associated with a ground truth mapping that defines a one-to-one mapping between each previous observation sₜ included in the context data and a vertex vₜ* in the graph model.

The system trains the neural network on sequences of context data sampled from the offline training data based on optimizing an objective function (step 704).

For each sequence of context data C_{1:T}, the objective function evaluates, at each time step, a difference between (i) a predicted probability distribution over a possible set of edges included in a first training network output of the neural network generated based on processing the portion of the sequence of context data up to the time step and (ii) a ground truth probability distribution that defines the set of ground truth edges eₖ*. For example, the ground truth probability distribution can include a probability score of one for each edge in the possible set of edges that is included in the set of ground truth edges eₖ* and a probability score of zero for each remaining edge in the possible set of edges that is not included in the set of ground truth edges eₖ*.

The objective function also evaluates, at each time step, a difference between (i) a predicted probability distribution over possible set of vertex-edge pairs included in the first training network output of the neural network generated based on processing the portion of the sequence of context data up to the time step and (ii) a ground truth probability distribution that defines the ground truth reward values rₖ* for the set of vertices.

The objective function further evaluates, at each time step, a difference between (i) a predicted probability distribution over a set of vertices included in a second training network output of the neural network generated based on processing the portion of the sequence of context data up to the time step and (ii) a ground truth probability distribution that includes a probability score of one for the vertex vₜ* defined by the ground truth mapping and a probability score of zero for each remaining vertex in the set of vertices.

In one example, the objective function can be defined as:

$$ℒ ( θ ) = {𝔼}_{p ( {C}_{1 : τ} , k )} [ \frac{1}{T} {\sum }_{t = 1}^{T} [ - ln ( {\hat{p}}_{θ} ( {e}_{k}^{*} , {r}_{k}^{*} \vert {C}_{1 : t} ) ) - ln ( {\hat{p}}_{θ} ( {υ}_{t}^{*} \vert {s}_{t} ) ) ] ] .$$

The system updates the values for the parameters θ of the neural networks based on using a machine learning training technique, e.g., a gradient descent with backpropagation training technique that uses a suitable optimizer, e.g., stochastic gradient descent, RMSprop, or Adam optimizer, to optimize the objective function.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for controlling an agent interacting with an environment to perform a task, and wherein the method comprises, at a current time step of multiple time steps:
maintaining context data that includes, for each of one or more previous time steps that precede the current time step, (i) data identifying a previous action performed by the agent at the previous time step and (ii) a previous observation characterizing a previous state that the environment transitioned into as a result of the agent performing the previous action;
receiving a current observation characterizing a current state of the environment;
generating a current graph model that represents the environment, wherein the current graph model comprises vertices that represent states of the environment and edges connecting the vertices, wherein an edge between a first vertex and a second vertex in the graph model indicates it is possible that the environment will transition from a state represented by the first vertex into a state represented by the second vertex as a result of one of a possible set of actions performed by the agent, and wherein generating the current graph model comprises:
processing a first Transformer network input that includes the context data using a Transformer neural network to generate a probability distribution over a possible set of edges that can be included in the current graph model; and
selecting, in accordance with the probability distribution over the possible set of edges, a subset of the edges to be included in the current graph model;
selecting, from the possible set of actions and using the current graph model, a current action to be performed by the agent in response to the current observation;
controlling the agent to perform the selected current action to cause the environment to transition from the current state into a new state; and
updating the context data to include (i) data identifying the selected current action and (ii) a new observation characterizing the new state of the environment.

2. The method of claim 1, wherein selecting the subset of the edges to be included in the current graph model comprises:
determining a respective value for each of the possible set of edges using the probability distribution; and
selecting, from the possible set of edges, one or more edges having determined values that satisfy a threshold value.

3. The method of claim 1, wherein selecting the current action to be performed by the agent comprises:
generating, by using the Transformer neural network, a reward value for each vertex included in the graph model.

4. The method of claim 1, wherein selecting the current action to be performed by the agent comprises:
determining an action selection policy that corresponds to the current graph model by using a dynamic programming technique, wherein action selection policy specifies a mapping from the vertices to the edges included in the current graph model; and
using the action selection policy to select the current action.

5. The method of claim 4, wherein the dynamic programming technique comprises a value iteration technique.

6. The method of claim 3, wherein determining the action selection policy that corresponds to the current graph model by using the dynamic programming technique comprises:
performing the value iteration technique using the edges included in the current graph model and the reward values included in the current graph model.

7. The method of claim 1, wherein selecting the current action to be performed by the agent comprises:
processing a second Transformer network input that includes the current observation using the Transformer neural network to generate a probability distribution over the vertices included in the graph model; and
selecting, in accordance with the probability distribution over the vertices included in the graph model, a selected vertex as a vertex in the graph model that corresponds to the current observation.

8. The method of claim 7, wherein using the action selection policy to select the current action comprises:
querying the action selection policy using the selected vertex.

9. The method of claim 1, wherein the possible set of actions comprise a no-op action.

10. The method of claim 1, wherein the current graph models at different time steps include different numbers of edges, or a same number of edges that connect the vertices in different ways.

11. The method of claim 1, wherein parameter values of the Transformer neural network are fixed during the multiple time steps.

12. The method of claim 1, wherein current graph model represents a Markov decision process (MDP) defining transitions between different states the environment.

13. The method of claim 1, wherein the agent is a mechanical agent and the environment is a real-world environment.

14. The method of claim 13, wherein the agent is a robot.

15. The method of claim 1, wherein the environment is a real-world environment of a service facility comprising a plurality of items of electronic equipment and the agent is an electronic agent configured to control operation of the service facility.

16. The method of claim 1, wherein the environment is a real-world manufacturing environment for manufacturing a product and the agent comprises an electronic agent configured to control a manufacturing unit or a machine that operates to manufacture the product.

17. The method of claim 1, wherein the environment is a simulation of a real-world environment.

18. The method of claim 1, wherein the agent is a digital assistant and wherein actions performed by the agent include outputs that are provided by the digital assistant to a user.

19. The method of claim 18, wherein the outputs include one or more of:
text displayed to a user in a user interface of the digital assistant;
an image displayed to the user in the user interface of the digital assistant; or
speech output through one or more speakers of the digital assistant.

20. A system comprising one or more computers and one or more storage devices storing instructions that are operable, when executed by the one or more computers, to cause the one or more computers to perform operations for controlling an agent interacting with an environment to perform a task, and wherein the operations comprise, at a current time step of multiple time steps:
maintaining context data that includes, for each of one or more previous time steps that precede the current time step, (i) data identifying a previous action performed by the agent at the previous time step and (ii) a previous observation characterizing a previous state that the environment transitioned into as a result of the agent performing the previous action;
receiving a current observation characterizing a current state of the environment;
generating a current graph model that represents the environment, wherein the current graph model comprises vertices that represent states of the environment and edges connecting the vertices, wherein an edge between a first vertex and a second vertex in the graph model indicates it is possible that the environment will transition from a state represented by the first vertex into a state represented by the second vertex as a result of one of a possible set of actions performed by the agent, and wherein generating the current graph model comprises:
processing a first Transformer network input that includes the context data using a Transformer neural network to generate a probability distribution over a possible set of edges that can be included in the current graph model; and
selecting, in accordance with the probability distribution over the possible set of edges, a subset of the edges to be included in the current graph model;
selecting, from the possible set of actions and using the current graph model, a current action to be performed by the agent in response to the current observation;
controlling the agent to perform the selected current action to cause the environment to transition from the current state into a new state; and
updating the context data to include (i) data identifying the selected current action and (ii) a new observation characterizing the new state of the environment.

21. A computer storage medium encoded with instructions that, when executed by one or more computers, cause the one or more computers to perform operations for controlling an agent interacting with an environment to perform a task, and wherein the operations comprise, at a current time step of multiple time steps:
maintaining context data that includes, for each of one or more previous time steps that precede the current time step, (i) data identifying a previous action performed by the agent at the previous time step and (ii) a previous observation characterizing a previous state that the environment transitioned into as a result of the agent performing the previous action;
receiving a current observation characterizing a current state of the environment;
generating a current graph model that represents the environment, wherein the current graph model comprises vertices that represent states of the environment and edges connecting the vertices, wherein an edge between a first vertex and a second vertex in the graph model indicates it is possible that the environment will transition from a state represented by the first vertex into a state represented by the second vertex as a result of one of a possible set of actions performed by the agent, and wherein generating the current graph model comprises:
processing a first Transformer network input that includes the context data using a Transformer neural network to generate a probability distribution over a possible set of edges that can be included in the current graph model; and
selecting, in accordance with the probability distribution over the possible set of edges, a subset of the edges to be included in the current graph model;
selecting, from the possible set of actions and using the current graph model, a current action to be performed by the agent in response to the current observation;
controlling the agent to perform the selected current action to cause the environment to transition from the current state into a new state; and
updating the context data to include (i) data identifying the selected current action and (ii) a new observation characterizing the new state of the environment.
